(19) United States
(12) Patent Application Publication
(10) Pub. No.: US 2025/0358008 A1
(43) Pub. Date: Nov. 20, 2025

(54) BREAKOUT CABLING FOR MULTI-CHANNEL CABLING SYSTEM

(71) Applicant: Microsoft Technology Licensing, LLC, Redmond, WA (US)

(72) Inventors: Vasily LYUTSAREV, Cambridge (GB); Kai SHI, Cambridge (GB); Hugh WILLIAMS, Cambridge (GB); Daniel Jonathan Finchley CLETHEROE, Cambridge (GB); Kaoutar BENYAHYA, Cambridge (GB); Ariel GOMEZ DIAZ, Cambridge (GB); Shawn Yohanes SIEW, Cambridge (GB); Paolo COSTA, London (GB); Junyi LIU, Cambridge (GB); Jonathan WESTCOTT, Cambridge (GB); Adam SMITH, Cambridgeshire (GB)

(21) Appl. No.: 18/934,147

(22) Filed: Oct. 31, 2024

Related U.S. Application Data
(60) Provisional application No. 63/649,932, filed on May 20, 2024.

(51) Int. Cl. H04B 10/25; B26D 7/10

(52) U.S. Cl. CPC H04B 10/25; B26D 7/10

(57) ABSTRACT

A method comprising: cutting a plastic multicore fiber into two or more sub fibers; connecting each of the two or more sub fibers to respective additional fibers. Further, a method comprising: cutting a first plastic multicore fiber to remove part of the first plastic multicore fiber and provide a first sub fiber, the first sub fiber comprising a residual part of the first plastic multicore fiber; cutting a second plastic multicore fiber to remove part of the second plastic multicore fiber and provide a second sub fiber, the second sub fiber comprising a residual part of the second plastic multicore fiber; connecting an optical fiber to the first sub fiber and the second sub fiber using a connector.

### CROSS-REFERENCE TO RELATED APPLICATION

This application claims priority to U.S. Provisional Patent Application No. 63/649,932, entitled “BREAKOUT CABLING FOR MULTI-CHANNEL CABLING SYSTEM,” filed on May 20, 2024, the disclosure of which is incorporated herein by reference in its entirety.

### BACKGROUND

Today's data centers can comprise of thousands of racks, each of which contains tens of servers. Inside each server, there is a compute unit, (e.g., Central Processing Units (CPUs), and General Processing Units (GPUs)) as well as storage. These servers can be interconnected with each other through a data center network. The network can be built by many point-to-point links at a given topology, where each link comprises a cable with transceivers attached to each end.

However, the data rate at each end point continues to increase from 400 Gps to 800 Gps and even 1.6 Tbps. Having breakout functionality of the cable becomes extremely important not only to provide compatibility to lower rate ports, but also allow new network architectures that can be more robust to failures or more flexible for congestion control.

Currently fiber fan-in fan-out (FIFO) devices for glass multi-core fibers (MCFs) are designed to map each single individual cores in MCFs into individual single core fibers. There are no re-grouping functionalities in such FIFO devices and also not in active optical cables (AOC)/direct attached cables (DAC) breakout cables, and they can only support a small number of parallel channels. For large multiple-channel (>100) system, the manufacturing complication of such FIFO and re-grouping devices is extremely high.

Some examples described herein provide a method for providing breakout functionality for a single plastic fiber.

An example usage scenario may be found in optical communication fiber cables, such as those used in data centers.

### SUMMARY

According to one aspect disclosed herein, there is provided a method of cutting a plastic multicore fiber into two or more sub fibers; and connecting each of the two or more sub fibers to respective additional fibers.

According to another aspect provided herein, there is provided a method of cutting a first plastic multicore fiber to remove part of the first plastic multicore fiber and provide a first sub fiber, the first sub fiber comprising a residual part of the first plastic multicore fiber; cutting a second plastic multicore fiber to remove part of the second plastic multicore fiber and provide a second sub fiber, the second sub fiber comprising a residual part of the second plastic multicore fiber; and connecting an optical fiber to the first sub fiber and the second sub fiber using a connector. In some examples, one or more further sub fibers can be provided in a similar way, and then can also be connected to the optical fiber using the connector.

Thus, according to the disclosed methods, breakout functionality can be provided for a plastic multicore fiber. This allows groups of data channels to be split at the point where the plastic multicore fiber is split.

According to further aspects disclosed herein, there are provided a corresponding apparatus for each method.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

### BRIEF DESCRIPTION OF THE DRAWINGS

To assist understanding of the present disclosure and to show how embodiments may be put into effect, reference is made by way of example to the accompanying drawings in which:

FIG. 1 is a diagram of a single fiber split into four individual fibers;

FIG. 2 is a schematic block diagram of a method for cutting a single fiber into sub fibers;

FIG. 3 is a schematic block diagram showing how the sub fibers of FIG. 2 can be connected to further fibers;

FIG. 4 is a schematic block diagram of a method for cutting a fiber into the shape of a sub fiber;

FIG. 5 is a schematic block diagram showing how a sub fiber provided by the method of FIG. 4 can be connected to an additional fiber;

FIG. 6 is a flow chart describing methods disclosed herein;

FIG. 7 is a flow chart describing methods disclosed herein.

### DETAILED DESCRIPTION OF EMBODIMENTS

Examples described herein provide a method for splitting a single fiber into at least two sub fibers. Target usage scenarios include optical communication fiber cables, such as those used in data centers, for example.

In cables that are used in current data center networks, to have a breakout functionality is relatively simple from a physical layer design. This is because inside each of these cables, there are multiple (e.g., 4, 8 or 16) bundles of sub cables, for example, that would be individual fibers in active AOCs or copper twinax cables in DACs. To break out the cable, it is only required to sperate each of these sub cables into an individual cable, either connectorized or terminated into a transceiver module.

However, when a single fiber cable is used for e.g., a transceiver link, bundles of sub cables cannot be split into an individual cable. There may be a number of parallel channels within a single fiber cable of the transceiver link. It is desired to provide a method where a single fiber can be split into sub fibers which can each be used as a transceiver link. Low additional loss and minimum enhancement of crosstalk is preferred during such a splitting process.

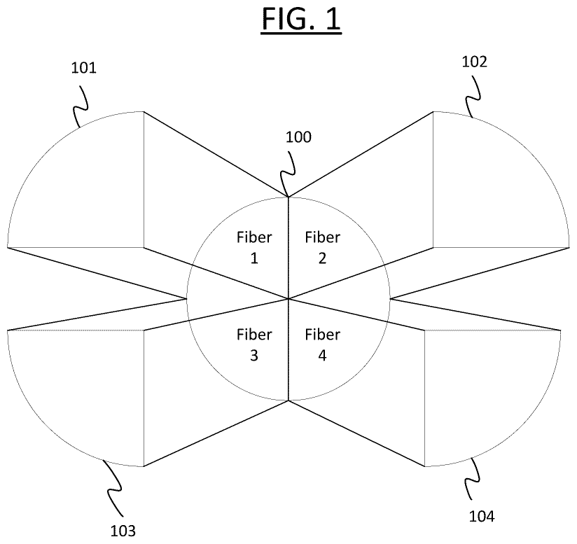

FIG. 1 shows an example single fiber 100 split into four sub fibers: fiber 1 101, fiber 2 102, fiber 3 103 and fiber 4 104.

A group of data packets can be sent over single fiber 100. Single fiber 100 could be used as a transceiver link, for example. Fiber 100 may be a single plastic fiber. Fiber 100 may be split into the four sub fibers 101, 102, 103 and 104 using the methods disclosed herein. It should be noted that although fiber 100 is split into four sub fibers in the example of FIG. 1, fiber 100 may be split into any desired number of sub fibers in other examples.

In the example of FIG. 1 where fiber 100 is split into four sub fibers 101, 102, 103 and 104, the group of data packets sent over fiber 100 may be split into four sub groups of data packets. A first sub group of data packets may be sent over sub fiber 101, a second sub group of data packets may be sent over sub fiber 102, a third subgroup of data packets may be sent over sub fiber 103 and a fourth sub group of data packets may be sent over sub fiber 104. Again, it should be noted that in examples where fiber 100 is split into a different number of sub fibers, the group of data packets may be split into an equivalent number of sub groups and sent over the respective sub fibers. In general, where there are N sub fibers of a single fiber, the group of data packets sent over the single fiber may be split into N sub groups of the group of data packets.

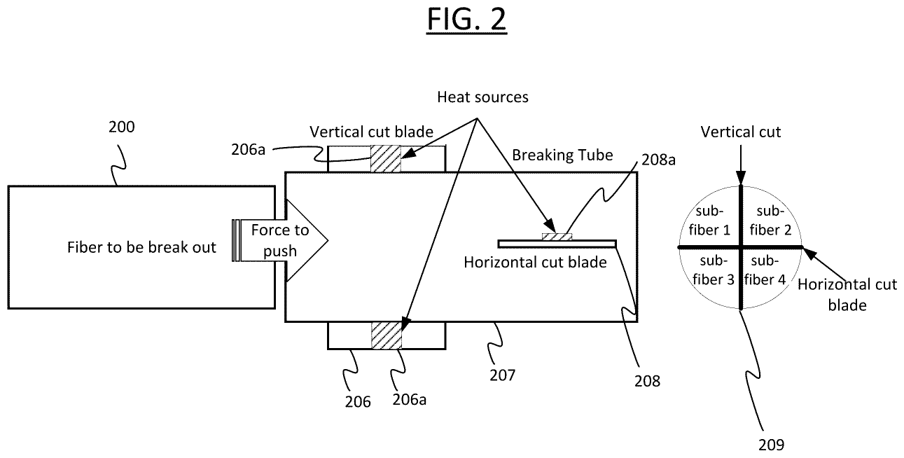

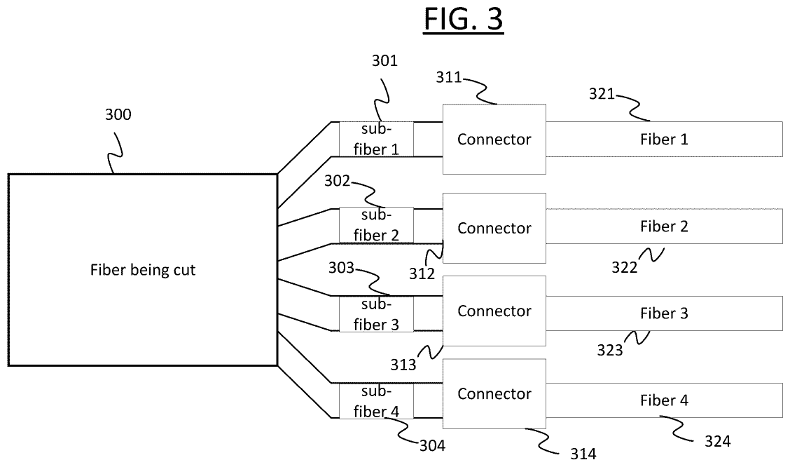

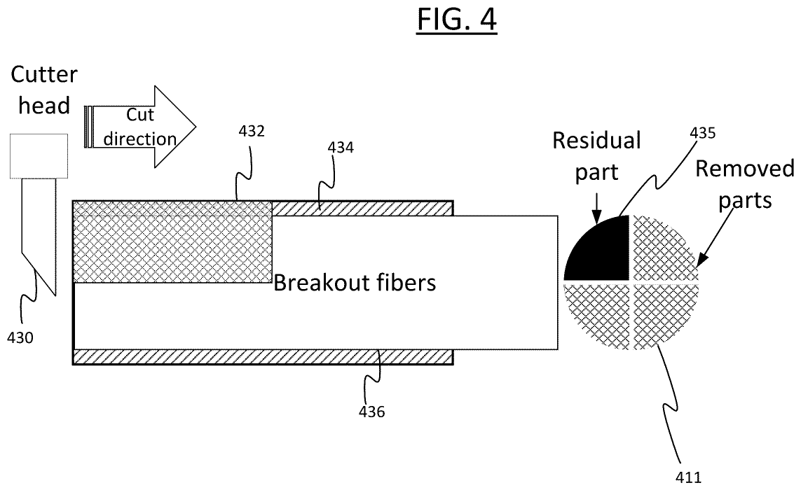

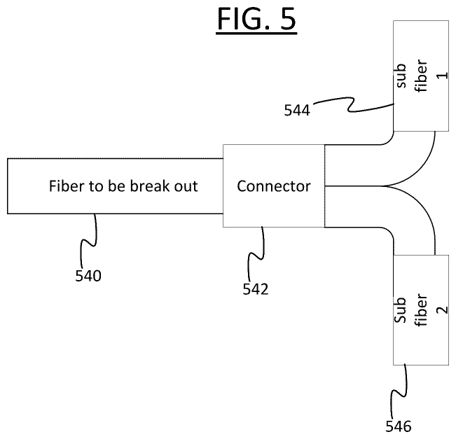

Two methods for splitting a single fiber into sub fibers are provided herein. A first method, the “cut and split” method, described below with respect to FIG. 2 and FIG. 3, cuts the fiber into sub fibers. These sub fibers can be connected with individual fibers that serve as breakout fibers. A second method, the “cut and combined” method, described below with respect to FIG. 4 and FIG. 5, cuts two or more fibers into a desired shape of a sub fiber, and then connects the sub fibers to a single fiber using a connector to achieve breakout functionality.

In both methods, the single fiber that is split into sub fibers may be a plastic multicore fiber, such as those typically used as plastic imaging fibers. An example of such a fiber is a poly(methyl methacrylate), PMMA, fiber. A multicore fiber may be considered to contain multiple cores (e.g., light guiding cores) within a single strand of fiber.

FIG. 2 shows a method for cutting an individual fiber 200 into sub fibers (the “cut and split” method). Fiber 200 is pushed into a tube 207, which may have a similar diameter to fiber 200. Inside tube 207, there are blades 206 and 208. In the example of FIG. 2, only vertical and horizontal blades are shown, but for the system where the breakout cable needs to be greater than four additional blades can be added (or removed, if for example, 2 or 3 breakout cables are needed). In some examples, heat source contacts 206a and 208a are provided on each of the blades 206 and 208, and these can be used to heat up the blades to the optimum temperature to cut fiber 200. The optimum temperature may be selected based on the material used in fiber 200. When the fiber is pushed through the tube, the fiber is cut into multiple sub fibers (in this example, the fiber is cut into four sub fibers as shown at 209).

After a certain length of cutting along fiber 200 as shown in FIG. 2, it has been found that fiber 200 may rotate, leading to a loss of usable fiber area. A threshold rotation angle (a maximum allowed rotation) of fiber 200 around its longitudinal axis can be set to limit the loss of usable fiber area. After a length of cutting (e.g., after a suitable length has been cut that can be used to connect to an additional fiber), it is therefore useful to attach the sub fibers to additional fibers. This can be performed using a connector, such as an epoxy material. The additional fibers may have a longer length than the sub fibers, and a larger diameter than the sub fibers. FIG. 3 shows an example where a fiber that has been split into sub fibers 301, 302, 303 and 304 are each respectively connected using connectors 311, 312, 313 and 314 to an additional fiber 321, 322, 323 and 324. As shown in FIG. 3, single fiber 300 is split into:
sub fiber 301, attached to additional fiber 321 by connector 311;
sub fiber 302, attached to additional fiber 322 by connector 312;
sub fiber 303, attached to additional fiber 323 by connector 313;
sub fiber 304, attached to additional fiber 324 by connector 314.

In the example of FIG. 3, a group of data packets may be sent along single fiber 300. The group of data packets may be split into four sub groups, which are each sent over one of sub fibers 301, 302, 303 and 304. The four sub groups of data packets may be further sent over the respective additional fiber 321, 322, 323 and 324 for each of sub fiber 301, 302, 303 and 304.

Although the examples of FIGS. 2 and 3 show a single fiber being split into four sub fibers, the method may be used more generally to split a single fiber into N fibers, where N is a positive integer. This can be performed by arranging the blades shown in FIG. 2 to cut the single fiber into N sub fibers. Then, N connectors can be used to attach the N sub fibers to N additional fibers. A group of data packets sent over the single fiber can then be split into N subgroups of data packets.

FIG. 4 shows a method (the “cut and combined” method) where multiple breakout fibers such as fiber 436 are first cut into the shape of the sub fibers that are required for a given number of break out cables. This can be achieved, for example, by using a computer numerical control (CNC) machine, where a cutter head 430 can be precisely controlled by the CNC machine to cut the material into any arbitrary geometry. Fiber 436 may be held in a holding tube 434. The removed parts of fiber 436 are shown at 432 and at 411. If the breakout number of cables required is 4, then only 1 quadrant 435 of the fiber remains and the other quadrants of the fiber are removed as shown at 411. Similar to the method of FIGS. 2 and 3 above (the “cut and split” method), this number can be changed according to the required number of breakout cables.

After all the individual breakout fibers are cut into the appropriate shape, the residual parts of these fibers are combined to form a shape that can match the fiber to be breakout as shown in FIG. 5. The length of the breakout fiber that can be cut depends on the travel range of the cutter head. This length can be selected to be large enough to allow bending and margin when the sub fibers 544 and 546 are combined by a connector (e.g., an epoxy) as shown in FIG. 5. The sub fibers 544 may be connected to a first end of a connector 542, and a single fiber 540 to be broken out may be connected to a second end of the connector 542. As shown in FIG. 5, the second end of the connector is opposite to the first end of the connector. As the rest of the breakout fiber that has not been cut has a larger area compared to the tip that has been cut, when the sub fibers are combined, attention needs to be taken to guarantee that they do not clash with each other while combining them by allowing the bending and margin as discussed above. It should be noted that in other examples, more than two sub fibers may be combined. The length may be selected in order to allow the sub fibers to be combined without clashing, while bending the sub fibers such that the bend radius of the sub fiber is greater than a threshold minimum bend radius for each of the sub fibers (where the minimum bend radius could be different for each sub fiber, according to some examples). According to some examples, the minimum bend radius may comprise a threshold bend radius below which the sub fiber is damaged or cannot operate efficiently/correctly.

In general, N sub fibers may be combined using the method of FIGS. 4 and 5. This can be performed by cutting N fibers as shown in FIG. 4 to provide N fibers each with a residual part. During the cutting process for each fiber, a fraction of the cross-sectional area of a plastic multicore fiber is removed along part of the length of the fiber, in order to provide a sub fiber. These sub fibers then can be connected together into one end of a connector, such that they form sub fibers for a single fiber connected into the other end of the connector. In some examples, the fraction of the cross-sectional area removed to provide each sub fiber may be the same for each sub fiber.

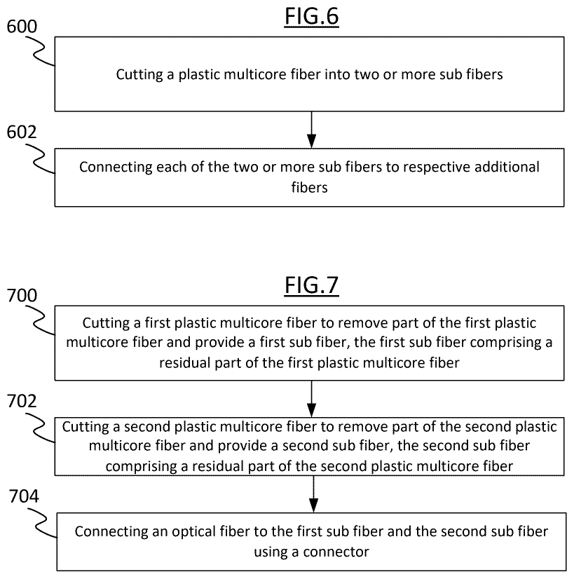

FIG. 6 illustrates a method of providing a breakout cable.

At 600, the method comprises cutting a plastic multicore fiber into two or more sub fibers.

At 602, the method comprises connecting each of the two or more sub fibers to respective additional fibers.

FIG. 7 illustrates a method of providing a breakout cable.

At 700, the method comprises cutting a first plastic multicore fiber to remove part of the first plastic multicore fiber and provide a first sub fiber, the first sub fiber comprising a residual part of the first plastic multicore fiber.

At 702, the method comprises cutting a second plastic multicore fiber to remove part of the second plastic multicore fiber and provide a second sub fiber, the second sub fiber comprising a residual part of the second plastic multicore fiber.

At 704, the method comprises connecting an optical fiber to the first sub fiber and the second sub fiber using a connector.

In some examples, one or more further sub fibers can be provided in a similar way, and then can also be connected to the optical fiber using the connector.

All of the disclosed operations or method steps, including those expressed in mathematical terms, may be implemented using suitable machine logic steps.

### Closing Remarks

It will be appreciated that the above embodiments have been disclosed by way of example only.

More generally, according to one aspect disclosed herein, there is provided a method comprising: cutting a plastic multicore fiber into two or more sub fibers; connecting each of the two or more sub fibers to respective additional fibers.

According to some examples, cutting the plastic multicore fiber into two or more sub fibers comprises: pushing the plastic multicore fiber into a tube, wherein the tube comprises blades for cutting the plastic multicore fiber into the two or more sub fibers.

According to some examples, each of the blades comprises a heat source contact.

According to some examples, pushing the plastic multicore fiber into the tube comprises: pushing the plastic multicore fiber a distance into the tube such that the plastic multicore fiber rotates less than a threshold rotation angle.

According to some examples, the additional fibers have a diameter equal to or larger than the diameter of the respective sub fiber of the two or more sub fibers to which the sub fibers are connected to.

According to some examples, the plastic multicore fiber comprises a PMMA fiber.

According to some examples, the method comprises sending a group of data packets over a section of the plastic multicore fiber which has not been cut; splitting the group of data packets into two or more sub groups of data packets; sending a first sub group of data packets over a first sub fiber of the two or more sub fibers; sending a second sub group of data packets over a second sub fiber of the two or more sub fibers.

According to some examples, the connecting each of the two or more sub fibers to respective additional fibers comprises connecting each of the two or more sub fibers using an epoxy material.

According to an aspect disclosed herein, there is provided an apparatus comprising: a plastic multicore fiber split into two or more sub fibers; two or more connectors, wherein each connector is connected to a respective sub fiber of the two or more sub fibers at a first end of the connector; additional optical fibers connected to a second end of each connector of the two or more connectors.

According to some examples, the plastic multicore fiber comprises a poly(methyl methacrylate), PMMA, fiber.

According to some examples, the connector comprises an epoxy material.

According to one aspect disclosed herein, there is provided a method comprising: cutting a first plastic multicore fiber to remove part of the first plastic multicore fiber and provide a first sub fiber, the first sub fiber comprising a residual part of the first plastic multicore fiber; cutting a second plastic multicore fiber to remove part of the second plastic multicore fiber and provide a second sub fiber, the second sub fiber comprising a residual part of the second plastic multicore fiber; connecting an optical fiber to the first sub fiber and the second sub fiber using a connector.

According to some examples, the first plastic multicore fiber and the second plastic multicore fiber are cut using a computer numerical control (CNC) machine.

According to some examples, the plastic multicore fiber comprises a poly(methyl methacrylate), PMMA, fiber.

According to some examples, the method comprises: sending a group of data packets over a section of the plastic multicore fiber which has not been cut; splitting the group of data packets into two or more sub groups of data packets; sending a first sub group of data packets over a first sub fiber of the two or more sub fibers; sending a second sub group of data packets over a second sub fiber of the two or more sub fibers.

According to some examples, the connector comprises an epoxy material.

According to some examples, the residual part of the first plastic multicore fiber and the residual part of the second plastic multicore fiber each have a length allowing bending of the first sub fiber and the second sub fiber to fit the first sub fiber and second sub fiber into the connector while: the bend radius of the first sub fiber is greater than a first threshold minimum bend radius; the bend radius of the second sub fiber is greater than a second threshold minimum bend radius;

According to some examples, the first sub fiber and the second sub fiber are connected to a first end of the connector and the optical fiber is connected to a second end of the connector, wherein the first end is opposite the second end.

According to some examples, cutting the first plastic multicore fiber to remove part of the first plastic multicore fiber and provide the first sub fiber comprises cutting the first plastic multicore fiber to remove a first fraction of the cross sectional area of the first plastic multicore fiber along a first length of the first plastic multicore fiber, wherein the first length is less than the length of the whole first plastic multicore fiber; and cutting the second plastic multicore fiber to remove part of the second plastic multicore fiber and provide the second sub fiber comprises cutting the second plastic multicore fiber to remove a second fraction of the cross sectional area of the second plastic multicore fiber along a second length of the second plastic multicore fiber, wherein the second length is less than the length of the whole second plastic multicore fiber.

According to some examples, the method comprises: cutting a third plastic multicore fiber to remove a part of each of the third plastic multicore fiber and provide a third sub fiber, the third sub fiber comprising a residual part of the third plastic multicore fiber; connecting the third sub fiber to the optical fiber, the first sub fiber and the second sub fiber using the connector.

According to one aspect disclosed herein, there is provided an apparatus comprising: an optical fiber connected to a first end of a connector; two or more sub fibers connected to a second end of the connector, wherein each of the two or more sub fibers comprises a residual part of a plastic multicore fiber after part of the plastic multicore fiber has been removed.

According to some examples, the plastic multicore fiber comprises a poly(methyl methacrylate), PMMA, fiber.

According to some examples, the optical fiber comprises a plastic multicore fiber.

According to some examples, the optical fiber comprises a PMMA fiber.

According to some examples, the connector comprises an epoxy material.

Other variants or use cases may become apparent to a person skilled in the art once given the disclosure herein. The scope of the present disclosure is not limited by the above-described embodiments, but only by the accompanying claims.

1. A method comprising:
cutting a plastic multicore fiber into two or more sub fibers;
connecting each of the two or more sub fibers to respective additional fibers.

2. The method of claim 1, wherein cutting the plastic multicore fiber into two or more sub fibers comprises:
pushing the plastic multicore fiber into a tube, wherein the tube comprises blades for cutting the plastic multicore fiber into the two or more sub fibers.

3. The method of claim 2, wherein each of the blades comprises a heat source contact.

4. The method of claim 2, wherein pushing the plastic multicore fiber into the tube comprises:
pushing the plastic multicore fiber a distance into the tube such that the plastic multicore fiber rotates less than a threshold rotation angle.

5. The method of claim 1, wherein the additional fibers have a diameter equal to or larger than the diameter of the respective sub fiber of the two or more sub fibers to which the sub fibers are connected to.

6. The method according to claim 1, wherein the plastic multicore fiber comprises a poly(methyl methacrylate), PMMA, fiber.

7. The method according to claim 1, comprising:
sending a group of data packets over a section of the plastic multicore fiber which has not been cut;
splitting the group of data packets into two or more sub groups of data packets;
sending a first sub group of data packets over a first sub fiber of the two or more sub fibers;
sending a second sub group of data packets over a second sub fiber of the two or more sub fibers.

8. The method according to claim 1, wherein the connecting each of the two or more sub fibers to respective additional fibers comprises connecting each of the two or more sub fibers using an epoxy material.

9. An apparatus comprising:
a plastic multicore fiber split into two or more sub fibers;
two or more connectors, wherein each connector is connected to a respective sub fiber of the two or more sub fibers at a first end of the connector;
additional optical fibers connected to a second end of each connector of the two or more connectors.

10. The apparatus according to claim 9, wherein the plastic multicore fiber comprises a poly(methyl methacrylate), PMMA, fiber.

11. The apparatus according to claim 9, wherein the connector comprises an epoxy material.

12. A method comprising:
cutting a first plastic multicore fiber to remove part of the first plastic multicore fiber and provide a first sub fiber, the first sub fiber comprising a residual part of the first plastic multicore fiber;
cutting a second plastic multicore fiber to remove part of the second plastic multicore fiber and provide a second sub fiber, the second sub fiber comprising a residual part of the second plastic multicore fiber;
connecting an optical fiber to the first sub fiber and the second sub fiber using a connector.

13. The method according to claim 12, wherein the first plastic multicore fiber and the second plastic multicore fiber are cut using a computer numerical control (CNC) machine.

14. The method according to claim 12, wherein the plastic multicore fiber comprises a poly(methyl methacrylate), PMMA, fiber.

15. The method according to claim 12, comprising:
sending a group of data packets over a section of the plastic multicore fiber which has not been cut;
splitting the group of data packets into two or more sub groups of data packets;
sending a first sub group of data packets over a first sub fiber of the two or more sub fibers;
sending a second sub group of data packets over a second sub fiber of the two or more sub fibers.

16. The method according to claim 12, wherein the connector comprises an epoxy material.

17. The method according to claim 12, wherein the residual part of the first plastic multicore fiber and the residual part of the second plastic multicore fiber each have a length and diameter allowing bending of the first sub fiber and the second sub fiber to fit the first sub fiber and second sub fiber into the connector while:
the bend radius of the first sub fiber is greater than a first threshold minimum bend radius;
the bend radius of the second sub fiber is greater than a second threshold minimum bend radius.

18. The method according to claim 12, wherein the first sub fiber and the second sub fiber are connected to a first end of the connector and the optical fiber is connected to a second end of the connector, wherein the first end is opposite the second end.

19. The method according to claim 12, wherein cutting the first plastic multicore fiber to remove part of the first plastic multicore fiber and provide the first sub fiber comprises cutting the first plastic multicore fiber to remove a first fraction of the cross sectional area of the first plastic multicore fiber along a first length of the first plastic multicore fiber, wherein the first length is less than the length of the whole first plastic multicore fiber;
and wherein cutting the second plastic multicore fiber to remove part of the second plastic multicore fiber and provide the second sub fiber comprises cutting the second plastic multicore fiber to remove a second fraction of the cross-sectional area of the second plastic multicore fiber along a second length of the second plastic multicore fiber, wherein the second length is less than the length of the whole second plastic multicore fiber.

20. The method according to claim 12, wherein the method comprises
cutting a third plastic multicore fiber to remove a part of each of the third plastic multicore fiber and provide a third sub fiber, the third sub fiber comprising a residual part of the third plastic multicore fiber;
connecting the third sub fiber to the optical fiber, the first sub fiber and the second sub fiber using the connector.
